(19) United States
(12) Patent Application Publication
(10) Pub. No.: US 2019/0185977 A1
(43) Pub. Date: Jun. 20, 2019

(54) STEEL FOR PRODUCING RAILWAY WHEELS

(71) Applicant: RAIL 1520 IP LTD, Limassol (CY)

(72) Inventors: Yuriy Alekseevich BEZOBRAZOV, Murino (RU); Oleg Arkadievich BROYTMAN, Saint-Petersburg (RU); Maksim Igorevich TERENTIEV, Murino (RU); Anna Mikhailovna ORLOVA, Saint-Petersburg (RU); Kirill Valterovich KYAKK, Saint-Petersburg (RU); Roman Aleksandrovich SAVUSHKIN, Moscow (RU)

(73) Assignee: Rail 1520 IP Ltd, Limassol (CY)

(21) Appl. No.: 16/302,371

(22) PCT Filed: May 3, 2017
(86) PCT No.: PCT/IB2017/000518

§ 371 Date: Nov. 16, 2018

(30) Foreign Application Priority Data
May 19, 2016 (RU) 2016119331

(51) Int. Cl. C22C 38/46; C22C 38/42; C22C 38/06; C22C 38/04; C22C 38/02; C22C 38/00; B60B 17/00

(52) U.S. Cl. CPC C22C 38/46; C22C 38/42; C22C 38/06; B60B 2360/102; C22C 38/02; C22C 38/002; B60B 17/00; C22C 38/04

(57) ABSTRACT

The invention relates to metal industry and more particularly to alloy for producing steel wheels, as well as to steel wheels made from such alloy for railway transport. The steel comprises the following components, in % wt.: from 0.45% wt. to 0.60% wt. of carbon, from 0.38% wt. to 0.50% wt. of silicon, from 0.80% wt. to 1.00% wt. of manganese, up to 0.15% % wt. of vanadium, from 0.80% wt. to 1.00% wt. of chromium, up to 0.02% wt. of phosphorus, up to 0.015% wt. of sulfur, up to 0.3% wt. of copper, up to 0.25% wt. of nickel, up to 0.04% wt. of aluminum, a balance of iron. The claimed steel alloy for use in producing railway wheels, either by metal working process or by casting methods, has improved mechanical and operational properties.

### TECHNICAL FIELD

The invention relates to metal industry and can be used for producing steel railway wheels for railway transport.

### BACKGROUND ART

Known is a wheel steel having following chemical composition % wt: 0.35-0.70% of carbon, 0.20-0.60% of silicon, 0.50-1.20% of manganese, 0.08-0.20% of vanadium, 0.30-0.50% of cuprum and the balance of iron (SU 451785, IPC C22C39/00, published on 30 Nov. 1974).

This prior art wheel steel exhibits insufficient hardness, fatigue strength, and crack resistance.

Known is a steel alloy for railway wheels, comprising following components, % wt: from 0.40 to 0.77% of carbon, from 0.25 to 0.60% of silicon, from 0.40 to 1.20% of manganese, less than 0.06% of aluminum, less than 0.03% of phosphorus, up to 0.03% of sulfur, up to 0.35% of nickel, up to 0.35% of chromium, up to 0.005% of calcium, up to 0.015% nitrogen, the balance of iron and impurities (U.S. Pat. No. 6,663,727 B2, C22C38/00, C22C38/40, C21D9/34, published on 20 Jun. 2002).

The prior art steel alloy is highly resistant to rim destruction. However, the alloy is characterized by low impact strength and relatively low wear-resistance.

### DISCLOSURE OF INVENTION

A technical result achieved by the invention is in improving mechanical properties (strength, hardness, impact strength) and operational properties (wear-resistance, crack resistance, cold resistance) of steel for producing wheels for railway vehicles.

The above-mentioned technical result is achieved by the fact that the claimed steel comprises following components, % wt:
from 0.45 to 0.60% of carbon;
from 0.38 to 0.50% of silicon;
from 0.80 to 1.00% of manganese;
up to 0.15% of vanadium;
from 0.80 to 1.00% of chromium;
up to 0.02% of phosphorus;
up to 0.015% of sulfur;
up to 0.30% of cuprum;
up to 0.25% of nickel;
up to 0.04% of aluminum;
the balance of iron.

The chemical composition of the proposed steel has been composed on the basis of the following.

The carbon content in the claimed steel within the range (0.45-0.60) % provides the required strength, hardness, wear and crack resistance. When the carbon content is less than 0.45% the quantity of carbide phase is decreased, therefore strength properties and wear resistance are decreased as well. When the carbon content is more than 0.6% the liability to brittle fracture is decreased.

The silicon content in the range of (0.38-0.50) % and the manganese content in the range of (0.80-1.00) % provide the required hardness penetration and increasing of a solid solution hardening.

The vanadium content being up 0.15% provides the more stable carbide phase VC (vanadium carbide) that allows controlling the size of austenite grain. A small size and homogeneous distribution of vanadium carbides facilitate steel strengthening and increasing of an impact resistance.

Chromium is the base carbide-forming element. The chromium content from 0.80% to 1.00% provides the required hardness penetration of steel, strength retention at high temperatures, improving steel wear resistance due to chromium carbides, and facilitates formation of highly dispersed structure of pearlite.

The phosphorus content being up to 0.02% and sulfur content being up to 0.015% are supposed to be effective since increased contents of these components negatively effect on the impact resistance, especially at low temperatures.

The copper content being up to 0.3% provides stabile strength properties of steel while maintaining a desired level of impact resistance.

Nickel in the concentration range of up to 0.25% is essential for increasing the impact resistance, cold resistance, and liability to brittle fracture.

Aluminum nitrides actively prevent austenite grains from growing, helping to form fine structure and as a result increasing impact resistance. However, due to re-oxidation of metallic jet in pouring process, scrap level is increased; therefore, the aluminum content is limited to 0.04%.

The steel of the proposed chemical composition allows producing high-strength railway wheels by metal forming methods as well as by casting methods. In order to manufacture high-strength cast steel railway wheels, the mechanical and operational properties should be set mainly by chemical composition of steel, by modification thereof, by solidity of casting, and by further operations of heat treatment and shot peening.

### BEST MODE FOR CARRYING OUT THE INVENTION

The invention is implemented as follows and is illustrated in an example of producing cast railway wheels.

Using thermodynamic analysis approach and computer-based simulation methods, the appropriate chemical composition of steel was found, which composition providing the desired combination of properties. Theoretical calculations are supported by results of tests on mechanical properties and material microstructure parameters of wheels being produced in in series of test heats.

Cast wheels produced from the steel according to the claimed chemical composition in batch of test heats after heat treatment (quenching of rim and subsequent temper), exhibit high strength and operational properties with the desired plastic properties degree and impact strength, including:
rim hardness at a depth of 30 mm from tread surface is not less than 330 HB;
ultimate resistance of rim is not less than 1050 MPa;
impact strength in rim at +20° C. is not less than 25 J/cm2;
impact strength in wheel plate at +20° C. is not less than 32 J/cm2;
impact strength in wheel plate at −60° C. is not less than 16 J/cm2;
hardness of wheel plate is not less than 230 HB; and
ultimate resistance of wheel plate is not less than 900 MPa.

1. A steel for producing railway wheels, wherein the steel comprises the following components, % wt.:
from 0.45% wt. to 0.60% wt. of carbon,
from 0.38% wt. to 0.50% wt. of silicon,
from 0.80% wt. to 1.00% wt. of manganese,
up to 0.15% wt. of vanadium,
from 0.80% wt. to 1.00% wt. of chromium,
up to 0.02% wt. of phosphorus,
up to 0.015% wt. of sulfur,
up to 0.30% wt. of copper,
up to 0.25% wt. of nickel,
up to 0.04% wt. of aluminum, and
a balance of iron.

2. The steel according to claim 1, wherein the steel comprises 0.15% wt. of vanadium.

3. The steel according to claim 1, wherein the steel comprises 0.02% wt. of phosphorus.

4. The steel according to claim 1, wherein the steel comprises 0.015% wt. of sulfur.

5. The steel according to claim 1, wherein the steel comprises 0.30% wt. of copper.

6. The steel according to claim 1, wherein the steel comprises 0.25% wt. of nickel.

7. The steel according to claim 1, wherein the steel comprises 0.04% wt. of aluminum.

8. A steel railway wheel comprising a plate and a rim, the rim having a tread surface, wherein the steel railway wheel comprises the following components, % wt.:
from 0.45% wt. to 0.60% wt. of carbon,
from 0.38% wt. to 0.50% wt. of silicon,
from 0.80% wt. to 1.00% wt. of manganese,
up to 0.15% wt. of vanadium,
from 0.80% wt. to 1.00% wt. of chromium,
up to 0.02% wt. of phosphorus,
up to 0.015% wt. of sulfur,
up to 0.30% wt. of copper,
up to 0.25% wt. of nickel,
up to 0.04% wt. of aluminum, and
a balance of iron.

9. The steel railway wheel of claim 8, wherein hardness of the rim at a depth of 30 mm from the tread surface is at least 330 BH.

10. The steel railway wheel of claim 8, wherein resistance of the rim is not less than 1050 MPa.

11. The steel railway wheel of claim 8, wherein impact strength of the rim at +20° C. is not less than 25 J/cm2.

12. The steel railway wheel of claim 8, wherein hardness of the plate is at least 230 BH.

13. The steel railway wheel of claim 8, wherein resistance of the plate is not less than 900 MPa.

14. The steel railway wheel of claim 8, wherein impact strength of the plate at +20° C. is not less than 32 J/cm2.

15. The steel railway wheel of claim 8, wherein impact strength of the plate at −60° C. is not less than 16 J/cm2.
